(19) United States
(12) Patent Application Publication
(10) Pub. No.: US 2007/0045051 A1
(43) Pub. Date: Mar. 1, 2007

(54) Method of Transporting a User by a Transport Means, Particularly by an Elevator

(75) Inventor: Bernhard Gerstenkorn, Ebikon (CH)

Correspondence Address: BUTZEL LONG, STONERIDGE WEST, 41000 WOODWARD AVENUE, BLOOMFIELD HILLS, MI, 48304, US

(73) Assignee: Inventio AG, Hergiswil NW (CH)

(21) Appl. No.: 11/459,982

(22) Filed: Jul. 26, 2006

(30) Foreign Application Priority Data
Jul. 28, 2005 (EP) 05106986.2

(51) Int. Cl. B66B 1/16

(52) U.S. Cl. 187/380

(57) ABSTRACT

A method of transporting a user by a transport, particularly by an elevator, utilizes a control unit, a first communications unit and a mobile second communications unit carried by the user. A destination call is lodged at the control unit by the second communications unit. The control unit determines at least one transport for serving the destination call. The transport is made known to the user on the second communications unit. Moreover, the control unit generates a destination signal and communicates this to the first communications unit. The transport transports the user to a destination corresponding with the destination call. The destination signal is transmitted by the first communications unit to the second communications unit and made known to the user on the second communications unit.

### BACKGROUND OF THE INVENTION

The present invention relates to a method of transporting a user by a transport means, particularly by an elevator. A control unit, a first communications unit and a mobile second communications unit carried by the user are provided for performance of the method. In the method initially a destination call is lodged by the user at the control unit, which thereupon determines a transport means for serving the destination call. After making known the transport means to the user, the user can seek the transport means and is transported to the desired destination.

A method of operating an elevator is known from European patent EP 1 282 578 B1, wherein a user of the elevator communicates a travel request by means of a man/machine interface to the elevator which then executes the desired journey. For this purpose a communications unit of the user is provided as control unit for the elevator. The control unit is provided with programs and data necessary for controlling the elevator and is used temporarily for controlling the elevator. The control unit is provided for a specific time with functions enabling elevator control.

However, in elevator systems of that kind there is the disadvantage that the user has to watch the display unit in the elevator car for substantially the entire duration of the journey so as to check whether, when the elevator stops, there is arrival at the desired destination floor or whether the journey has to be continued.

### SUMMARY OF THE INVENTION

The present invention has the object of so developing a method of transporting a user that the user reliably recognizes, particularly without having to watch a display unit, when he or she has reached his or her travel destination.

According to the present invention for fulfillment of this object in the case of a method of transporting a user by a transport means, particularly by an elevator, wherein a control unit, a first communications unit and a mobile second communications unit carried by the user are provided to perform a method that comprises the following steps:

a) lodging a destination call at the control unit by means of the second communications unit;

b) determination, by the control unit, of at least one transport means for serving the destination call;

c) making known the transport means to the user by means of the second communications unit;

d) generating a destination signal by the control unit and communicating the destination signal to the first communications unit;

e) transporting the user by the transport means to a destination corresponding with the destination call;

f) transmitting the destination signal from the first communications unit to the second communications unit; and

g) making known the destination signal to the user by means of the second communications unit.

The method according to the present invention is based on the recognition that, independently of the construction of the transport means, the user is given the knowledge—by means of a mobile communications unit which serves for making known the destination signal and is carried by the user and which is in mutual communication with the first communications unit and/or the control unit—that he or she has reached or will shortly reach his or her destination. In other words, the mobile communications unit serves as a mobile destination signal transmitter. The Bluetooth or Zigbee standard can advantageously be used for the data exchange.

The method according to the present invention proves particularly advantageous when for lodging the destination call by the second communications unit the NEC standard is used at the destination call terminal. The communications parameters of the second communications unit are transferred to the destination call terminal together with the destination call and passed on by the destination call terminal to the control unit for subsequent establishing of the communications connection between the first communications unit and the second communications unit. Thanks to this method the pairing between the first communications unit and the second communications unit takes place without a time delay recognizable by the user and without manipulations of the second communications unit having to be undertaken by the user.

The method according to the present invention proves particularly advantageous when due to a restricted possibility of viewing the destination display unit or as a consequence of a reduced vision capability, particularly in the case of a sight handicap, it is not possible for the user to optically recognize data made known with the help of this display unit.

By way of the data exchange between the first communications unit, which is contact with the control unit and preferably arranged at or in the region of the transport means, and the second communications unit carried by the user it is possible, apart from making known the destination signal, to also communicate further data such as, for example, the instantaneous position of the transport means, intermediate stopping points and opening and closing movements of any doors of the transport means. This makes a simple orientation possible for the user. Making known the destination signal preferably takes place by way of a vibration alarm by means of the mobile communications unit, but can also take place optically or acoustically.

In an advantageous development of the method according to the present invention it is provided that the access authorization of the user is checked before determination of the transport means and the transport means is determined only if the check of the access authorization is successful. It is ensured by this measure that only users with access authorization can obtain data with respect to movement to the vicinity of the transport means, for example with respect to guidance in a building.

It is further of advantage if an access code, particularly for access to a closed room, is communicated when making known the transport means to the user and/or when transporting the user and/or when transmitting the destination signal. An additional security measure is provided in this manner. Thus, for example, in the case of a general access authorization for access to a building it is possible to give to the user specific part access authorizations for specific regions in the building by means of appropriately generated access codes.

In order to grant access to a user on whose mobile communications unit an access code was filed already before lodging the destination call it is possible for the second communications unit to communicate the access code to the first communications unit.

It has proved advantageous, particularly in the case of a complex transport system with a plurality of transport means, for example in the case of a building complex with several elevators, if data for guidance of the user to the transport means are transmitted to the second communications unit together with making known the transport means to the user. It can thus be ensured that the user finds the way to the transport means, which is determined by the control unit, in an environment, which is possibly strange to the user, with the help of the second communications unit carried by user. Making known the data by the second communications unit preferably takes place by way of a display unit or a speech output by means of the second communications unit.

In a development of the method according to the present invention it is proposed that the destination signal is transmitted in step e) and/or made known in the step g) during transport of the user or, at the latest, before further travel of the transport means. Thus, the time period between reception of the destination call by the control unit and entry of the transport means by the user can be used for the purpose of determination of data of any kind by the control unit or a central computer unit connected with the control unit and for communication either by way of the first communications unit to the second communications unit or directly to the second communications unit.

It is further of advantage if, on transmission of the destination signal from the first communications unit to the second communications unit, data for guidance of the user, particularly for guidance in a building, are communicated to the second communications unit. Thus, for the case that, for example, the user during the journey with the transport means would like to change his or her travel destination and makes known to the control unit by means of the second communications unit the change of the travel destination, a corresponding adaptation of the data, for example a new access code or adapted data for guidance of the user, can be communicated.

According to a preferred development of the method it is provided that several transport means are determined by the control unit and the user selects one of the determined transport means by means of the second communications unit and subsequently data for guidance of the user to the selected transport means are communicated to the second communications unit. This adaptation to the individual needs of the user is advantageous, for example, when the user wants to use not the transport means recommended by the control unit, but another transport means.

According to a preferred development of the method it is provided that if during the waiting time of the user the allocated or selected transport means is no longer a good choice because, for example, it has broken down or is significantly delayed, the control unit determines an optimum transport means again and communicates to the second communications unit the changed allocation and data for guidance of the user to the changed transport means.

In order to inform the user in suitable manner that the user's destination has been reached or will be shortly reached, the making known of the destination signal takes place by way of an optical, acoustic or vibrating signal unit of the second communications unit.

A mobile telephone is preferably used as second communications unit. It is thus possible to avoid an obligation for the user to carry, apart from the user's mobile telephone, a further mobile communications unit. The transport means is preferably an elevator with at least one elevator car, wherein the elevator car is provided with the first communications unit.

In an advantageous development of the method the destination signal is transmitted from the first communications unit to the second communications unit by means of a short-distance radio connection. For this purpose the first communications unit is advantageously provided in the region of the transport means, i.e., for example, arranged at or in the transport means, and equipped in such a manner that it can exchange data with the second communications unit preferably with use of the Bluetooth standard.

The range of the near field is preferably less than about 10 meters. This means that contact between the mobile communications unit and the first communications unit or the second communications unit comes into being only when the units provided for the data exchange are at a spacing of less than about 10 meters. In this connection it has provided particularly advantageous that use can be made within such a distance oft in particular the Bluetooth standard as transmission standard for the data transmission.

In an advantageous development of the invention a service offered by the local mobile radio operator is used as communications standard for the radio connection for data exchange between the first communications unit and the second communications unit when the first and/or the second communications unit does not have a short-distance radio system. For this purpose the first communications unit is advantageously provided in the region of the control unit, i.e., for example, arranged in an elevator engine room, and equipped in such a manner that it can exchange data with the second communications unit preferably with use of the CSD or GPRS standard.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a schematic cross-sectional view of an elevator installation in a building according to the present invention.

### DESCRIPTION OF THE PREFERRED EMBODIMENT

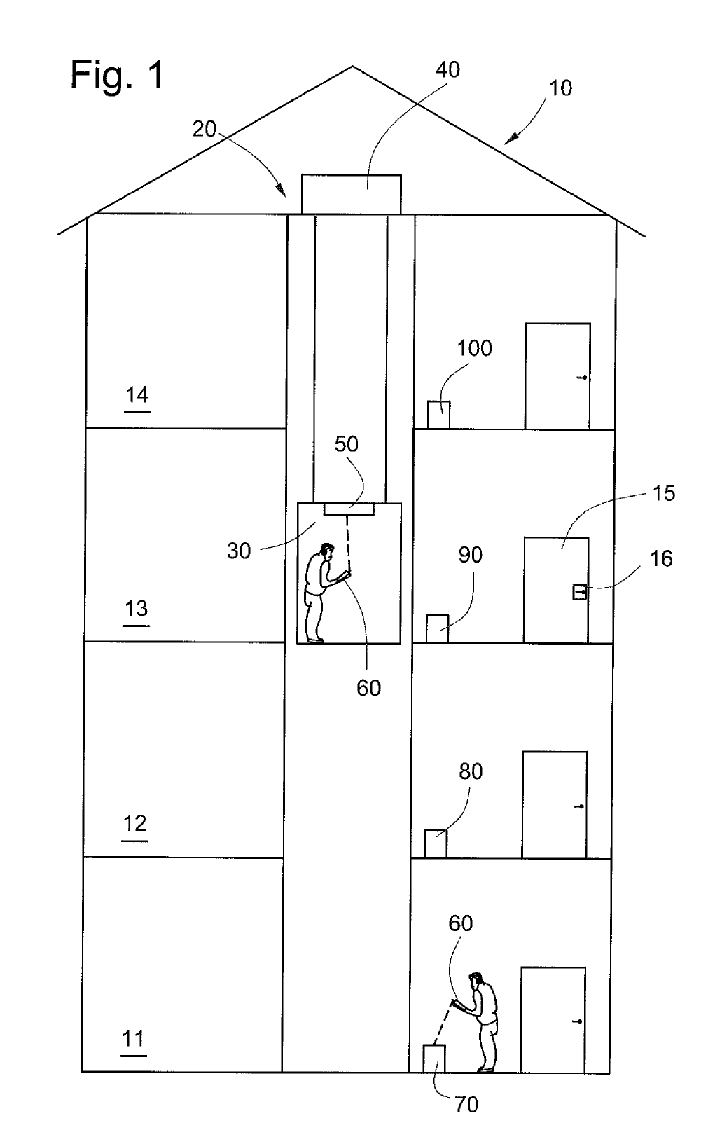

FIG. 1 schematically shows a building 10 with an elevator installation with several elevators 20, only one of which is shown, wherein each of these elevators 20 comprises a vertically movable elevator car 30 operating as a transport means and a control unit 40 in order to make possible transport of a user by the elevator 20. The transport system additionally comprises a first communications unit 50 which is equipped for transmission and reception of data and is arranged at the elevator car 30. Moreover, destination call terminals 70, 80, 90 and 100 are connected by way of a data line with the control unit 40 and are provided in the region of the elevator unit 20 on each of the floors 11, 12, 13 and 14 respectively.

A method for transport of a user by the elevator 20 is explained in the following on the basis of this system. After the user carrying a mobile second communications unit 60, in the form of a mobile telephone or a PDA (Personal Digital Assistant), has entered the building 10 at the first floor 11 (ground floor) the user approaches the elevator 20. As soon as the user is in the vicinity of the terminal 70, i.e. at a spacing of less than about ten meters, the mobile telephone 60 automatically receives a contact signal transmitted by the terminal 70 and accepts contact with the terminal 70 and thus also with the control unit 40 connected with the terminal 70 by way of a data line or a radio system. After acceptance of contact the user lodges a destination call at the control unit 40 by means of the mobile telephone 60. The destination call contains, as destination, the statement of the desired floor to which the user wants to be transported. This destination call delivery takes place automatically, but can also take place by way of a manual or speech-controlled operation of the mobile telephone 60. On the basis of the delivered destination call the control unit 40 determines, in the present case, the elevator car 30 as suitable transport means for servicing the destination call. The result of this determination, i.e. the determination of the elevator car 30, is made known to the mobile telephone 60. For this purpose the user obtains, for example, a short message with the number of the determined elevator car 30. Moreover, the user obtains additional information by which he or she can find the way from the current location to the correct elevator door.

The control unit 40 further serves the purpose of generating a destination signal which is communicated to the first communications unit 50. After the user has entered the elevator car 30 the user is transported in the direction of the desired destination, i.e. to a specific floor. As soon as the elevator car 30 has reached the desired floor and come to a stop the doors of the elevator car open. Shortly before opening of the doors the first communications unit 50 transmits the destination signal to the mobile telephone 60, whereupon the vibration alarm and/or a call tone alarm of the mobile telephone 60 is activated. As a consequence of this alarm the user recognizes that the desired floor is reached and the user should prepare to alight or has to alight immediately. The communication of the destination signal from the first communications unit 50 to the mobile telephone 60 takes place by a radio connection with use of the Bluetooth standard.

In addition to the destination signal the first communications unit 50 communicates to the mobile telephone 60 an access code generated by control unit 40. This access code makes possible, for the user, access to a room closed by a door 15. The door 15 has an electronic door lock and a transmitter/receiver unit 16.

After leaving the elevator car 30 the user moves in the direction of the closed room. As soon as the user is at a spacing or less than about 2 meters from the door 15 the mobile telephone 60 receives a contact signal transmitted by the transmitter/receiver unit 16. After making contact with the transmitter/receiver unit 16 the mobile telephone 60 automatically transmits the access code to the transmitter/receiver unit 16. The received access code is compared by the transmitter/receiver unit 16 with an original access code filed in the control unit 40 or directly in the transmitter/receiver unit 16. In the case of agreement of the two access codes release of the door lock takes place, whereby access to the room is possible.

The afore-described method is distinguished particularly by the fact that the user just by carrying the mobile telephone 60 and without having to follow the position or movement of the elevator car is informed by way of the mobile telephone, on reaching or shortly before reaching the desired destination, that he or she has now reached or will shortly reach his or her destination.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method of transporting a user by a transport means, particularly by an elevator, wherein a control unit, a first communications unit and a mobile second communications unit carried by the user are provided and wherein the method comprises the following steps:
a. lodging a destination call at the control unit transmitted by the second communications unit;
b. determining a transport means for serving the destination call;
c. making known the determined transport means to the user on the second communications unit;
d. generating a destination signal from the control unit and communicating the destination signal to the first communications unit;
e. transporting the user by the transport means to a destination corresponding with the destination call;
f. transmitting the destination signal from the first communications unit to the second communications unit; and
g. making known the destination signal to the user on the second communications unit.

2. The method according to claim 1 wherein said step b. includes checking an access authorization of the user before determining the transport means and determining the transport means only if the check of the access authorization is successful.

3. The method according to claim 1 including communicating an access code, particularly for access to a closed room, to the second communications unit in at least one of said step c., said step e. and said step f.

4. The method according to claim 3 wherein the second communications unit communicates the access code to the first communications unit.

5. The method according to claim 1 wherein said step c. includes transmitting data to the second communications unit for guidance of the user to the transport means.

6. The method according to claim 1 wherein said step g. is performed either during the performance of said step e. or before further travel of the transport means from the destination.

7. The method according to claim 1 wherein said step f. is performed or said step g. is performed either during the performance of said step e. or before further travel of the transport means from the destination.

8. The method according to claim 1 including communicating data for guidance of the user, particularly for guidance in a building, to the second communications unit during the performance of said step f.

9. The method according to claim 1 wherein said step b. is performed by determining at least two transport means by the control unit and wherein the user selects a one of the at least two transport means by using the second communications unit and subsequently data for guidance of the user to the selected one transport means are communicated to the second communications unit.

10. The method according to claim 1 wherein when the transport means made known in said step c. changes before said step e. is performed, communicating this change to the second communications unit by the control unit together with data for guidance of the user to the changed transport means.

11. The method according to claim 1 wherein said step g. is performed using at least one of an optical, acoustic and vibrating signal unit of the second communications unit.

12. The method according to claim 1 wherein the second communications unit is one of a mobile telephone and a PDA.

13. The method according to claim 1 wherein the transport means is an elevator installation with at least one elevator car, the elevator car being provided with the first communications unit.

14. The method according to claim 1 including establishing a near-field radio connection between the destination call terminal and the second communications unit in said step a.

15. The method according to claim 1 including performing said step a. by delivering communications parameters of the second communications unit, which parameters are required for establishing a communications connection between the first communications unit and the second communications unit, to the control unit together with the destination call.

16. The method according to claim 1 including performing said step f. by transmitting the destination signal from the first communications unit to the second communications unit by a short-distance radio connection.

17. An elevator used as the transport means for performing the method according to claim 1 and wherein data of the control unit for the elevator, such as the destination signal, are transmitted from the first communications unit to the second communications unit by a data service of a local mobile radio operator.
